(19) United States
(12) Patent Application Publication
(10) Pub. No.: US 2024/0346529 A1
(43) Pub. Date: Oct. 17, 2024

(54) CONTEXT-BASED ACCOUNT GROUPINGS

(71) Applicant: Wells Fargo Bank, N.A., San Francisco, CA (US)

(72) Inventor: Jeffery Scott Parker, O'Fallon, MO (US)

(21) Appl. No.: 18/299,897

(22) Filed: Apr. 13, 2023

(51) Int. Cl. G06Q 30/0201; G06Q 30/0601

(52) U.S. Cl. CPC G06Q 30/0201; G06Q 30/0631

(57) ABSTRACT

Systems and techniques may generally be used for generating a contextual account grouping. An example technique may include accessing data corresponding to a plurality of customer accounts for a customer, receiving an API call for data corresponding to the customer, and in response to receiving the API call, automatically selecting, using processing circuitry, a grouping type for the plurality of customer accounts based on the API call. The example technique may include collecting information corresponding to a set of customer accounts of the plurality of customer accounts, the set of customer accounts corresponding to the selected grouping type, and responding to the API call with the information corresponding to the set of customer accounts.

### BACKGROUND

There are many types of data stored in disparate places for a user. For example, a user may have personal information, social information, account information, etc. Often each set of a user's data is stored without reference to other portions of the user's data, such as on different systems, with different organizations, or with different logins. Not only may the user's data not be contextualized, but some portions of the user's data may not be accessible, even to the user (e.g., metadata, tagging, organization-specific stored insights, etc.).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system diagram for generating a contextual account grouping in accordance with some embodiments.

FIG. 2 illustrates a swim lane diagram for generating a contextual account grouping in accordance with some embodiments.

FIG. 3 illustrates examples of accounts and groupings in accordance with some embodiments.

FIG. 4 illustrates machine learning engine for training and execution related to a contextual account grouping in accordance with some embodiments.

FIG. 5 illustrates a flowchart showing a technique for generating a contextual account grouping in accordance with some embodiments.

FIG. 6 illustrates generally an example of a block diagram of a machine upon which any one or more of the techniques discussed herein may perform in accordance with some embodiments.

### DETAILED DESCRIPTION

The systems and techniques described herein provide a contextual account grouping, such as for a particular user, a set of users, a requestor, or the like. The contextual account grouping may be generated based on a purpose for the grouping (e.g., a user for data related to the grouping, a requesting entity status such as internal, external, etc.). The purpose may be specified in a request for the contextual account grouping, for example in an Application Programming Interface (API) call requesting the contextual account grouping or for information related to a contextual account grouping. In an example, a request may not specify a contextual account grouping, but instead specify a purpose, a requestor, a user, etc. The contextual account grouping may be determined automatically. In some examples, identification of the contextual account grouping may be sent in response to a request. In other examples, data related to a determined contextual account grouping may be sent in response to a request. In some examples, both the contextual account grouping and data related to the contextual account grouping may be sent in response to a request.

In some examples, a request may be made via a website, an app (e.g., a mobile app), a text, an email, a phone call, etc. Context for a request may be based on a category of a requestor, a category of a user, a designated purpose for the request (e.g., in identity verification, personal use of a user, for backup, for determining a user's eligibility for a particular product, service, or offer, or the like).

A contextual account grouping may group one or more accounts or sets of information, such as of an account owned by a given customer (e.g., a checking account, a savings account, etc.), an account owned by a related household (e.g., as defined by customer), an associated party on an account (e.g., a spouse or beneficiary, or a related party, such as a CPA, a lawyer, an attorney in fact, etc.), a test account, a brokerage account, a credit card account, personal information, social network information, location information, mortgage information, information related to one or more assets or liabilities (e.g., a car loan, land ownership, etc.), employment information, or the like.

In some examples, a contextual account grouping may be determined based on a use, for example, according to a bank use for a particular concept. In an example a request may be made for information to determine a user's “net worth,” which may vary according to the use of the net worth. A contextual account grouping for a user's accounts or information for compiling a net worth may be identified based on the use of the net worth. For example, a customer may have a first net worth according to solely owned or held accounts, a second net worth based on household accounts or information, a third net worth based on brokerage account holdings, a fourth net worth that includes mortgages or other physical assets, a fifth net worth that includes debt, or the like. Each net worth may be used for different purposes. For example, a financial advisor may use a net worth with all possible data of the user, while a credit card offer may use a net worth based on a savings account and a checking account. Similarly, a request for “stock holdings” may in some examples include stock held in a 401k, while other times may include only individually held stocks, etc. In some examples, relevant accounts may be retrieved according to a contextual account grouping determined based on a regulatory request. For example, a fiduciary or trusted employee according to a law or regulation may be required to disclose familial relationships with holdings in a company, and so the contextual account grouping for this request may encompass a much broader set of accounts than a request for a user's financial data.

Data may be processed automatically to determine which contextual account grouping is to be selected. Contextual account groupings may be dynamic (e.g., generated for each request) or may be static (e.g., defined according to regulatory rules). Data received as part of a request may include explicit data such as a user identifier or a requested purpose or implicit data, such as an identifier of a requestor or metadata. Context for a grouping may be requestor dependent, customer dependent (e.g., account holder), viewer dependent, security dependent (e.g., according to data requested or use), for a particular login screen or login status, or the like.

In some examples, a contextual account grouping may include a time-based determination for selecting information to be grouped. For example, a request during market hours for stock related information may include delayed data or an estimate of data. In some examples, a context may be customer-defined or automatically determined. In an example, a request may specify a type of information sought. For example, as described above a net worth may be requested. Other examples may include a request for “assets” (e.g., which may include context regarding whether the assets are liquid vs illiquid for grouping), “available cash” (e.g., with or without cryptocurrencies or foreign held cash), or any other context defined concept for account groupings.

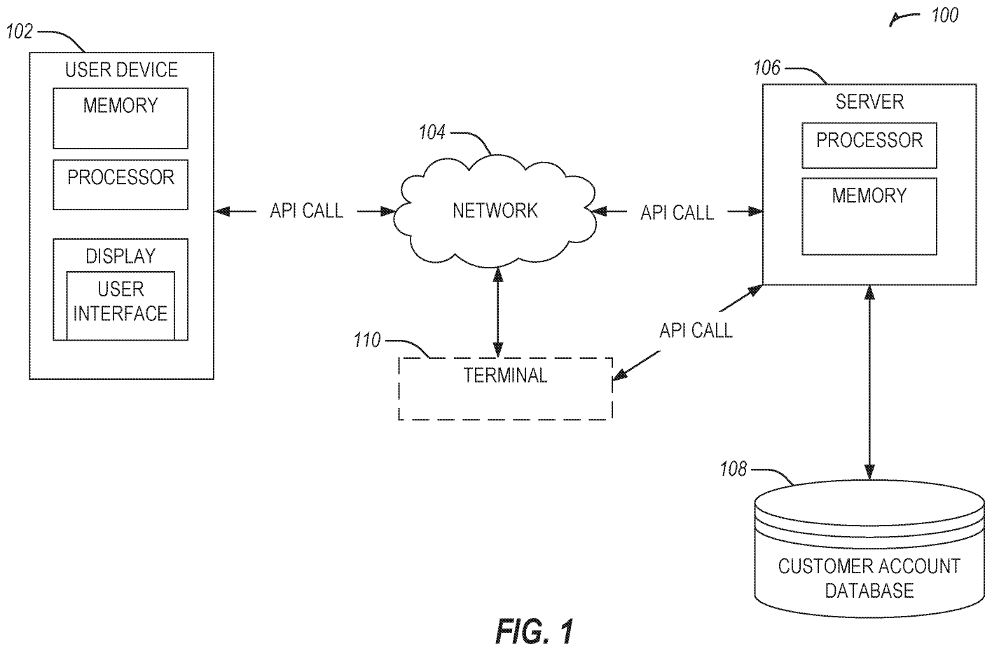

FIG. 1 illustrates a system diagram 100 for generating a contextual account grouping in accordance with some embodiments. The diagram 100 includes a user device 102, which may be used to make a request. The request may be sent (e.g., via an API call) via a network 104 to a server 106. In some examples, a terminal 110, such as a banking terminal or a market terminal may be used to make a request or provide information related to a request. Information to be sent in response to the request may be stored in a customer account database 108, which may include a plurality of databases or storage locations. The server 106 may receive the request and determine a contextual account grouping, for example using a processor and memory. The memory of the server 106 may store an algorithm, such as a trained machine learning model to determine the contextual account grouping in some examples.

In response to determining a contextual account grouping for a request, information may be obtained from the customer account database 108 (e.g., account details, holdings, dollar values, etc.) for accounts in the contextual account grouping. The server 106 may send a response to the request to the terminal 110 or the user device 102 or elsewhere (e.g., the request may originate at one device and the response may be sent to a different device). The response may include an indication of the contextual account grouping, an identification of accounts in the contextual account grouping, information relating to accounts in the contextual account grouping, or the like. In some examples, the information in the request or the response may be encrypted, subject to authorization or authentication, or the like. In an example, a contextual account grouping may differ depending on a requestor status (e.g., a financial advisor in training, a user with a particular clearance, a logged in user, etc.).

The user device 102 may include a processor and memory to generate the request to be sent. The user device 102 may include a display for presenting a user interface to provide information sent from the server 106 in response to the request. In an example, a context for a grouping may include determining a “household” for a particular user. The household may change based on a user for the data, such as to determine net worth, family assets, regulatory related disclosures, etc. In an example, the household may be used to determine recent activity, account balances, withdrawals made, trades, holdings, etc. The different accounts or information used to determine the household may include personal or investment accounts, shared accounts (e.g., with spouse joint account, account with family such as college savings, etc.).

What are the groupings of accounts may be determined or output dynamically to define a context in response to a request. The context may depend on a customer or on an enterprise employee (e.g., financial advisor, teller, sales, executive, regulatory oversight, human resources, etc.). For example, commission discounts occur sometimes for high trade values. In some examples, a high net worth customer may receive different offers (e.g., credit cards, mortgage rate, etc.) than a low net worth or average net worth customer. In regulatory considerations, a compliance review (e.g., for the Securities and Exchange Commission) for some trades or money laundering concerns with multiple accounts may be dependent on the determined household. In other examples, such as from a call center perspective, the determined household may be used to identify customer information, such as identifying that a caller has auto loan, mortgage, savings/checking account, etc. with a bank.

Household context may be dynamic, for example selected from among a set of household groupings for a particular purpose. In some examples more than one household or contextual account grouping may be determined, output, or otherwise displayed to a user (e.g., an enterprise employee, a client, etc.) for selection. For example, two household definitions may be selected and sent to a user to choose from for their particular purpose.

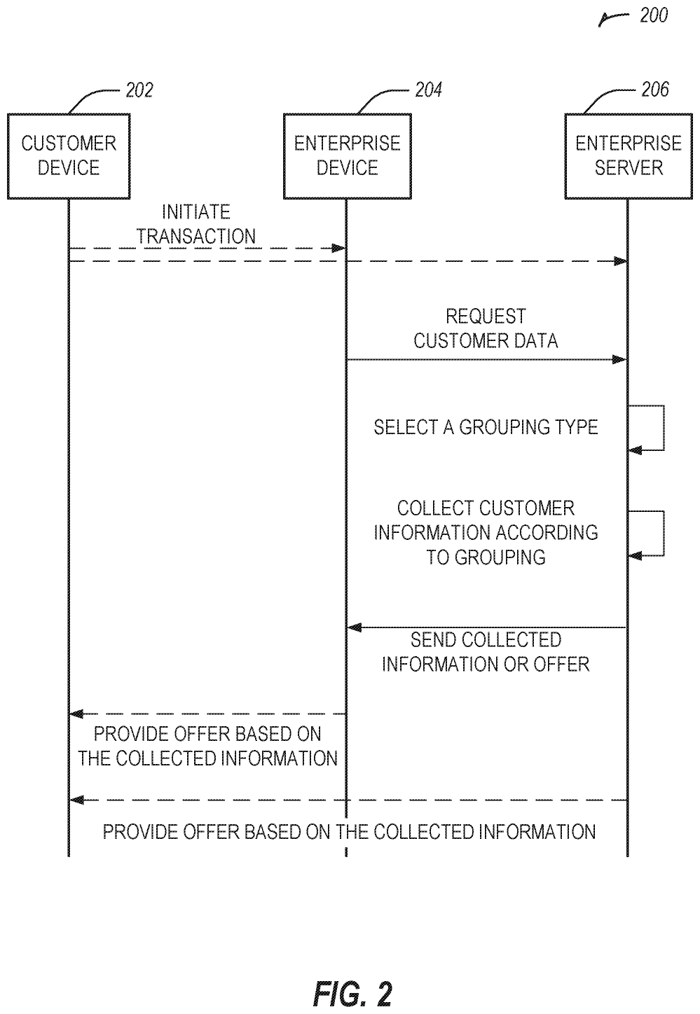

FIG. 2 illustrates a swim lane diagram 200 for generating a contextual account grouping in accordance with some embodiments. The swim lane diagram 200 includes a customer device 202, an enterprise device 204, and an enterprise server 206. Enterprise in this context may include a company (e.g., a bank or an insurance company), a subgroup of a company, an educational institution, or the like.

The customer device 202 may initiate a transaction by sending an initiation request to the enterprise device 204 or the enterprise server 206. If sent to the enterprise device 204, the enterprise device may request customer data from the enterprise server 206. If sent to the enterprise server 206 directly from the customer device 202, the enterprise device may treat the initiation as a request for customer data. In other examples, the enterprise device 204 my initiate the request without a customer initiating a transaction. A transaction may include an application, such as for a credit card, an account opening, a mortgage, etc., a purchase request (e.g., for stock on margin), a request for information (e.g., for qualifying offers for a mortgage interest rate, for investment opportunities, for a certificate of deposit, etc.), or the like.

After receiving the request for customer data, the enterprise server 206 may select or determine a grouping type (e.g., for accounts of the customer device 202). The enterprise server 206 may collect customer information according to the grouping, and send information to the enterprise device 204 (or directly to the customer device 202). The information sent may include the collected information itself, the grouping itself, or information derived from the collected information, such as a net worth, an offer corresponding to the collected information (e.g., for an interest rate, a savings account opening, etc.), or a combination. In some examples, the enterprise server 206 may send information to the enterprise device 204 and the customer device 202. This information may differ, such as providing the customer device 202 with an offer, and providing the enterprise device 204 with context for the offer (e.g., a range of acceptable offers for negotiation).

After the information is sent to the enterprise device 204, the enterprise device 204 may provide an offer to the customer device 202 based on the collected information. For example, when the enterprise server 206 does not determine an offer, but instead sends the collected information to the enterprise device 204, the enterprise device 204 may determine an offer to send to the customer device 202 or a user may determine an offer to send to the customer device 202. The customer device 202 may be used to accept the offer, such as by responding to the enterprise device 204 or the enterprise server 206.

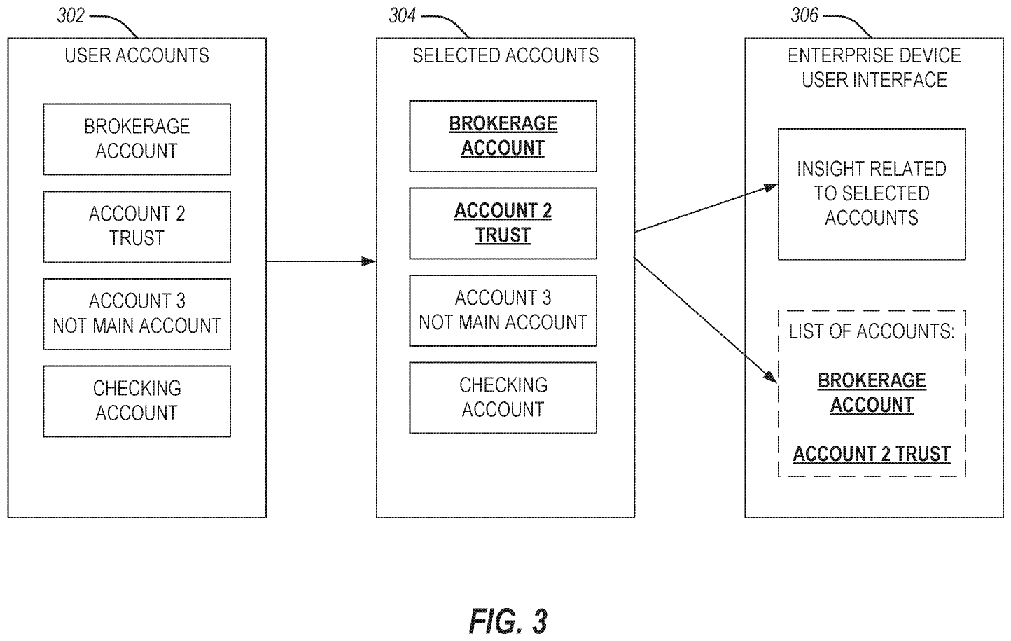

FIG. 3 illustrates examples of accounts and groupings in accordance with some embodiments. FIG. 3 includes a set of user accounts 302 corresponding to a user. Accounts of the user may be selected according to a contextual account grouping, as described herein. The selected accounts 304 may be displayed in a user interface in some examples. After the accounts are selected according to the contextual account grouping, an enterprise device user interface 306 may display information related to the contextual account grouping. For example, the enterprise device user interface 306 may display an insight related to accounts of the contextual account grouping (e.g., the selected accounts 304, shown in bold), a list of the accounts (e.g., shown in bold in the enterprise device user interface 306), or the like.

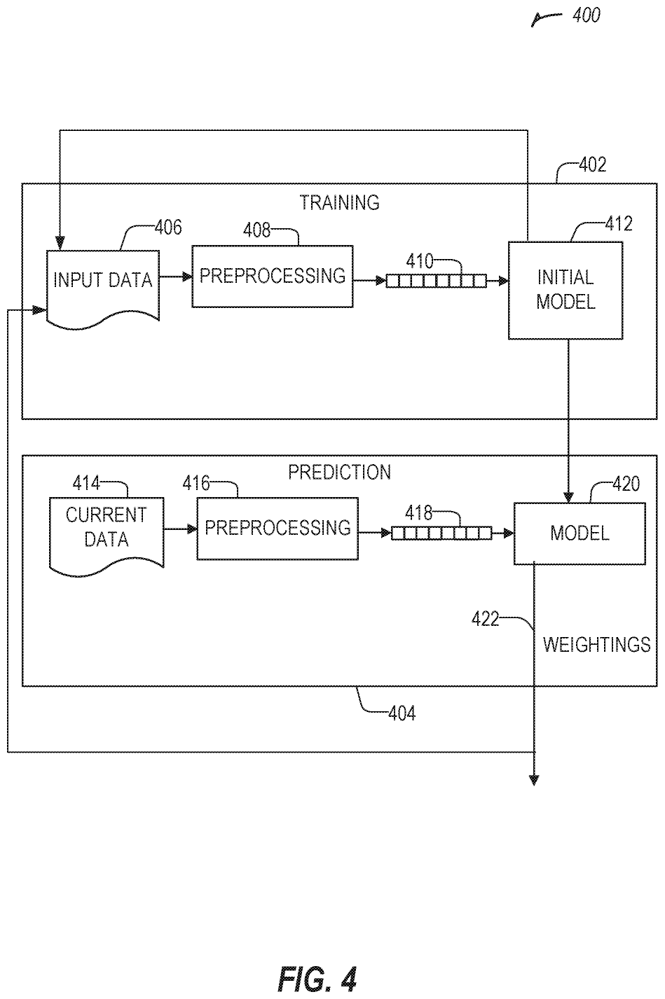

FIG. 4 illustrates machine learning engine for training and execution related to determining a contextual account grouping for a request in accordance with some embodiments. The machine learning engine may be deployed to execute at a mobile device (e.g., a cell phone) or a computer (e.g., an orchestrator server). A system may calculate one or more weightings for criteria based upon one or more machine learning algorithms. FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during reinforcement learning), for example to improve the performance of the prediction engine 404 or the initial model 412. An improved model may be redeployed for use.

The input data 406 may include a purpose for a request (e.g., a user for data related to the grouping, a requesting entity status such as internal, external, in identity verification, personal use of a user, for backup, for determining a user's eligibility for a particular product, service, or offer, or the like), a requestor (e.g., a job title, a company name, an entity requesting, etc.), a user or client (e.g., a person whose accounts are under consideration), or the like. The input data 406 may include real world or simulated accounts that are unlabeled or labeled with contextual account groupings, for example with an identified purpose, user, client, etc.

In the prediction engine 404, current data 414 (e.g., information received in a request, such as via an API, which may include a user, a use, a client, etc.) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user.

Labels for the input data 406 may include a list of accounts, a type of account, an account grouping, a context term (e.g., a request may be labeled with a “regulatory” term or a “mortgage” term, etc.), or the like.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 420 may output a contextual account grouping. In some examples, the model 420 may output a list of accounts corresponding to a determined contextual account grouping, information related to a determined contextual account grouping, etc. The model 420 may integrate or be supplemented with an additional algorithm that outputs relevant information related to the determined contextual account grouping, in some examples. The model 420 may output context or metadata related to how the determined contextual account grouping was selected, in some examples.

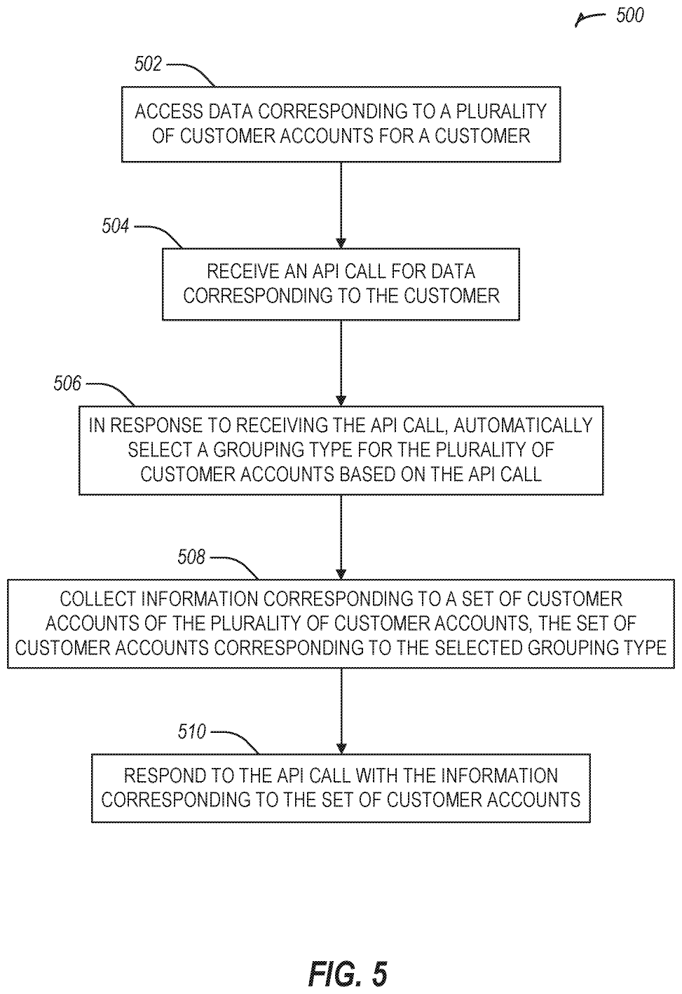

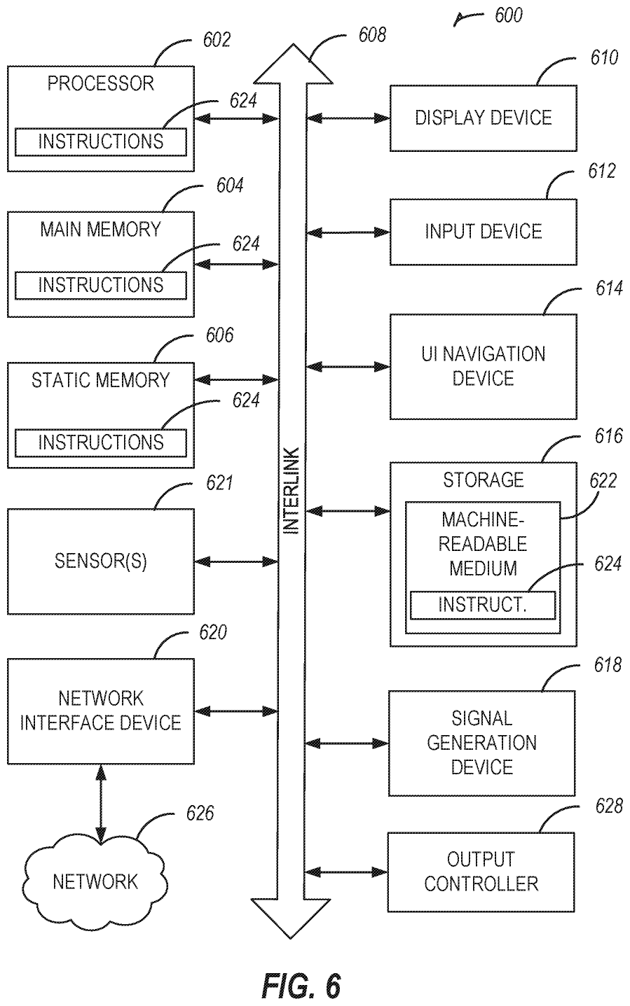

FIG. 5 illustrates a flowchart showing a technique 500 for generating a contextual account grouping in accordance with some embodiments. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 6.

The technique 500 includes an operation 502 to access data corresponding to a plurality of customer accounts for a customer. The technique 500 includes an operation 504 to receive an API call for data corresponding to the customer. In an example, the API call may be generated in response to an automated system receiving a call from the customer. The automated system may be part of a call center, a customer service line, generated via an internet communication, etc.

The technique 500 includes an operation 506 to in response to receiving the API call, automatically select, for example using processing circuitry, a grouping type for the plurality of customer accounts based on the API call. The selected grouping type may be selected based on an identified use for the data corresponding to the customer, the identified use being defined in the API call. Operation 506 may include using metadata of the API call, including a requesting entity (e.g., a bank employee, such as a financial advisor, a teller, etc., an insurance provider, a verifier service, such as for rent, mortgage, travel, etc., or the like). In an example, operation 506 includes selecting the grouping type based on an account owned by the customer, an account owned by a related household member of the customer (e.g., as defined by customer), a use of the data identified in the API call, a planning request, or the like. In some examples, different definitions for customer accounts or context may be applied in each subsegment of bank. For example, each subsegment may have a different definition of net worth. A customer may have a net worth according to solely held accounts, another net worth based on household accounts, another net worth based on a brokerage account, another net worth that includes mortgage, another net worth that includes debt, etc. The context-based account groupings may be used to automatically pull the correct net worth for the customer for the particular context (e.g., identified in the API call) of the request (e.g., for mortgage, pull household, but for credit score, pull solely held accounts). In some examples, operation 506 includes using a trained machine learning model.

The technique 500 includes an operation 508 to collect information corresponding to a set of customer accounts of the plurality of customer accounts, the set of customer accounts corresponding to the selected grouping type. Operation 508 may include determining a net value balance of the set of customer accounts, and wherein responding to the API call includes sending the net value balance of the set of customer accounts for the selected grouping type. The information output may be viewer dependent (e.g., different context for financial advisor, different context for customer, or for particular login screen, etc.). In some examples, the information may be selected according to a device, display, or user interface to be used to show the information (e.g., different information for a phone, a teller screen, a website, etc.).

The technique 500 includes an operation 510 to respond to the API call with the information corresponding to the set of customer accounts. The information may include a preselected offering of at least one of a service, a discount, a coupon, a credit card, a fee waiver or the like. The information may include a plurality of net worth values for the customer based on the selected grouping type. In other examples, the information may include assets (e.g., liquid assets, illiquid assets, or a combination), available cash (e.g., with or without cryptocurrencies or foreign held cash), or a custom banking context defined concept for account groupings. The information may include an identification of a regulatory control relationship of the customer. The regulatory control relationship may include a relationship that is regulated (e.g., must be disclosed to a regulatory body). The information may include a context for the selected grouping type based on the API call. For example, indicating a reason why a particular account was included or excluded for the customer (e.g., “this account was excluded because the customer is not a primary account holder”).

The technique 500 may include an operation to receive a second API call for the data corresponding to the customer, in response to receiving the second API call, automatically select, for example using processing circuitry, a second grouping type for the plurality of customer accounts based on the second API call and a second identified use for the data, collecting second information corresponding to a second set of customer accounts of the plurality of customer accounts, the second set of customer accounts corresponding to the selected second grouping type, and responding to the second API call with the second information corresponding to the set of customer accounts, the second information differing from the information. In this example, the customer and customer accounts may be the same as in operation 502, but a different grouping is selected and accordingly different information is provided. The second API call may include a different request (e.g., for a different use) or be from a different requestor, causing the second information to differ from the information.

FIG. 6 illustrates generally an example of a block diagram of a machine 600 upon which any one or more of the techniques (e.g., methodologies) discussed herein may perform in accordance with some embodiments. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, alphanumeric input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 that is non-transitory on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: accessing data corresponding to a plurality of customer accounts for a customer; receiving an API call for data corresponding to the customer; in response to receiving the API call, automatically selecting, using processing circuitry, a grouping type for the plurality of customer accounts based on the API call; collecting information corresponding to a set of customer accounts of the plurality of customer accounts, the set of customer accounts corresponding to the selected grouping type; and responding to the API call with the information corresponding to the set of customer accounts.

In Example 2, the subject matter of Example 1 includes, wherein the selected grouping type is selected based on an identified use for the data corresponding to the consumer, the identified use being defined in the API call.

In Example 3, the subject matter of Example 2 includes, receiving a second API call for the data corresponding to the customer; in response to receiving the second API call, automatically selecting, using processing circuitry, a second grouping type for the plurality of customer accounts based on the second API call and a second identified use for the data; collecting second information corresponding to a second set of customer accounts of the plurality of customer accounts, the second set of customer accounts corresponding to the selected second grouping type; and responding to the second API call with the second information corresponding to the set of customer accounts, the second information differing from the information.

In Example 4, the subject matter of Examples 1-3 includes, wherein selecting the grouping type includes using metadata of the API call, including a requesting entity.

In Example 5, the subject matter of Examples 1-4 includes, wherein the information includes a preselected offering of at least one of a service, a discount, a coupon, a credit card, or a fee waiver.

In Example 6, the subject matter of Examples 1-5 includes, wherein the API call is generated in response to an automated system receiving a call from the customer.

In Example 7, the subject matter of Examples 1-6 includes, wherein the information includes a plurality of net worth values for the customer based on the selected grouping type.

In Example 8, the subject matter of Examples 1-7 includes, wherein the information includes an identification of a regulatory control relationship of the customer.

In Example 9, the subject matter of Examples 1-8 includes, wherein the information includes a context for the selected grouping type based on the API call.

In Example 10, the subject matter of Examples 1-9 includes, wherein selecting the grouping type is based on an account owned by the customer, an account owned by a related household member of the customer, and a use of the data identified in the API call.

In Example 11, the subject matter of Examples 1-10 includes, wherein selecting the grouping type includes using a trained machine learning model.

In Example 12, the subject matter of Examples 1-11 includes, wherein collecting the information corresponding to the set of customer accounts of the plurality of customer accounts includes determining a net value balance of the set of customer accounts, and wherein responding to the API call includes sending the net value balance of the set of customer accounts for the selected grouping type.

Example 13 is at least one non-transitory machine-readable medium including instructions, which when executed by processing circuitry, causes the processing circuitry to perform operations to: access data corresponding to a plurality of customer accounts for a customer; receive an API call for data corresponding to the customer; in response to receiving the API call, automatically select a grouping type for the plurality of customer accounts based on the API call; collect information corresponding to a set of customer accounts of the plurality of customer accounts, the set of customer accounts corresponding to the selected grouping type; and respond to the API call with the information corresponding to the set of customer accounts.

In Example 14, the subject matter of Example 13 includes, wherein the selected grouping type is selected based on an identified use for the data corresponding to the consumer, the identified use being defined in the API call.

In Example 15, the subject matter of Examples 13-14 includes, wherein the selected grouping type is selected using metadata of the API call, including a requesting entity.

In Example 16, the subject matter of Examples 13-15 includes, wherein the information includes a preselected offering of at least one of a service, a discount, a coupon, a credit card, or a fee waiver.

In Example 17, the subject matter of Examples 13-16 includes, wherein the information includes a context for the selected grouping type based on the API call.

In Example 18, the subject matter of Examples 13-17 includes, wherein to collect the information corresponding to the set of customer accounts of the plurality of customer accounts, the operations include determining a net value balance of the set of customer accounts, and wherein responding to the API call includes sending the net value balance of the set of customer accounts for the selected grouping type.

Example 19 is a system comprising: processing circuitry; and memory, including instructions, which when executed by the processing circuitry, cause the processing circuitry to: access data corresponding to a plurality of customer accounts for a customer; receive an API call for data corresponding to the customer; in response to receiving the API call, automatically select a grouping type for the plurality of customer accounts based on the API call; collect information corresponding to a set of customer accounts of the plurality of customer accounts, the set of customer accounts corresponding to the selected grouping type; and respond to the API call with the information corresponding to the set of customer accounts.

In Example 20, the subject matter of Example 19 includes, wherein the selected grouping type is selected based on an identified use for the data corresponding to the consumer, the identified use being defined in the API call.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
accessing data corresponding to a plurality of customer accounts for a customer;
receiving an API call for data corresponding to the customer;
in response to receiving the API call, automatically selecting, using processing circuitry, a grouping type for the plurality of customer accounts based on the API call;
collecting information corresponding to a set of customer accounts of the plurality of customer accounts, the set of customer accounts corresponding to the selected grouping type; and
responding to the API call with the information corresponding to the set of customer accounts.

2. The method of claim 1, wherein the selected grouping type is selected based on an identified use for the data corresponding to the customer, the identified use being defined in the API call.

3. The method of claim 2, further comprising:
receiving a second API call for the data corresponding to the customer;
in response to receiving the second API call, automatically selecting, using processing circuitry, a second grouping type for the plurality of customer accounts based on the second API call and a second identified use for the data;
collecting second information corresponding to a second set of customer accounts of the plurality of customer accounts, the second set of customer accounts corresponding to the selected second grouping type; and
responding to the second API call with the second information corresponding to the set of customer accounts, the second information differing from the information.

4. The method of claim 1, wherein selecting the grouping type includes using metadata of the API call, including a requesting entity.

5. The method of claim 1, wherein the information includes a preselected offering of at least one of a service, a discount, a coupon, a credit card, or a fee waiver.

6. The method of claim 1, wherein the API call is generated in response to an automated system receiving a call from the customer.

7. The method of claim 1, wherein the information includes a plurality of net worth values for the customer based on the selected grouping type.

8. The method of claim 1, wherein the information includes an identification of a regulatory control relationship of the customer.

9. The method of claim 1, wherein the information includes a context for the selected grouping type based on the API call.

10. The method of claim 1, wherein selecting the grouping type is based on an account owned by the customer, an account owned by a related household member of the customer, and a use of the data identified in the API call.

11. The method of claim 1, wherein selecting the grouping type includes using a trained machine learning model.

12. The method of claim 1, wherein collecting the information corresponding to the set of customer accounts of the plurality of customer accounts includes determining a net value balance of the set of customer accounts, and wherein responding to the API call includes sending the net value balance of the set of customer accounts for the selected grouping type.

13. At least one non-transitory machine-readable medium including instructions, which when executed by processing circuitry, causes the processing circuitry to perform operations to:
access data corresponding to a plurality of customer accounts for a customer;
receive an API call for data corresponding to the customer;
in response to receiving the API call, automatically select a grouping type for the plurality of customer accounts based on the API call;
collect information corresponding to a set of customer accounts of the plurality of customer accounts, the set of customer accounts corresponding to the selected grouping type; and
respond to the API call with the information corresponding to the set of customer accounts.

14. The at least one machine-readable medium of claim 13, wherein the selected grouping type is selected based on an identified use for the data corresponding to the customer, the identified use being defined in the API call.

15. The at least one machine-readable medium of claim 13, wherein the selected grouping type is selected using metadata of the API call, including a requesting entity.

16. The at least one machine-readable medium of claim 13, wherein the information includes a preselected offering of at least one of a service, a discount, a coupon, a credit card, or a fee waiver.

17. The at least one machine-readable medium of claim 13, wherein the information includes a context for the selected grouping type based on the API call.

18. The at least one machine-readable medium of claim 13, wherein to collect the information corresponding to the set of customer accounts of the plurality of customer accounts, the operations include determining a net value balance of the set of customer accounts, and wherein responding to the API call includes sending the net value balance of the set of customer accounts for the selected grouping type.

19. A system comprising:
processing circuitry; and
memory, including instructions, which when executed by the processing circuitry, cause the processing circuitry to:
access data corresponding to a plurality of customer accounts for a customer;
receive an API call for data corresponding to the customer;
in response to receiving the API call, automatically select a grouping type for the plurality of customer accounts based on the API call;
collect information corresponding to a set of customer accounts of the plurality of customer accounts, the set of customer accounts corresponding to the selected grouping type; and
respond to the API call with the information corresponding to the set of customer accounts.

20. The system of claim 19, wherein the selected grouping type is selected based on an identified use for the data corresponding to the customer, the identified use being defined in the API call.
